(19) United States
(12) Patent Application Publication
(10) Pub. No.: US 2004/0083561 A1
(43) Pub. Date: May 6, 2004

(54) Aqueous dispersion comprising a u v absorbing compound

(76) Inventors: Jurg Heller, Oberwil (CH); Jean-Luc Mura, Rixheim (FR)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/472,740

(22) PCT Filed: Mar. 22, 2002
(86) PCT No.: PCT/IB02/00883

(30) Foreign Application Priority Data
Mar. 27, 2001 (GB) 0107523.3

(51) Int. Cl. C09B 1/00

(52) U.S. Cl. 8/648

(57) ABSTRACT

Aqueous dispersion comprising at least one U.V. absorbing compound of the following formula (I)

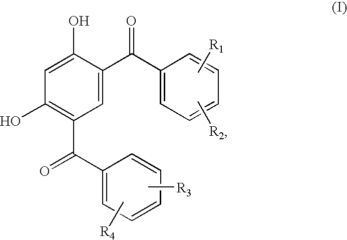

wherein

R₁ to R₄ independently of each other are hydrogen; C₁₋₄ alkyl; substituted C₂₋₄-alkyl; —OC₁₋₄alkyl; Oaryl; COC₁₋₂alkyl; COOC₁₋₂alkyl; aryl- or substituted aryl-radicals,

a process of treating a textile material with said dispersions as well as textiles treated with such a dispersion.

The present invention relates to a method of treating a textile with an aqueous dispersion comprising at least one U.V. absorbing compound selected from a specified group of U.V. absorbing compounds, in order to improve the light fastness of the thus treated textile, to an aqueous dispersion of said compounds and to use of the U.V. absorbing compounds for textile treatment.

It is known to treat textiles with an aqueous dispersion of a specific U.V. absorbing compound in order to improve the light fastness of the thus treated textile. The object of the present invention is to provide further aqueous dispersions of a U.V. absorbing compound which are suitable for treating textiles in order to improve the light fastness of the thus treated textiles. The aqueous dispersions according to the present invention have not previously been disclosed in the form of an aqueous dispersion. Furthermore a number of the compounds suitable for use in the present invention, have not previously been known.

The present invention accordingly provides an aqueous dispersion comprising at least one of the U.V. absorbing compounds of the following formula (I)

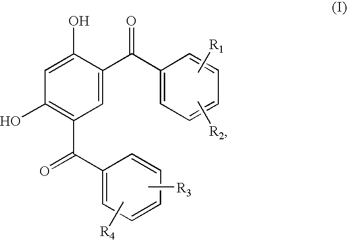

wherein R₁ to R₄ independently of each other are hydrogen; C₁₋₄ alkyl; substituted C₂₋₄-alkyl; OC₁₋₄alkyl; Oaryl; COC₁₋₂alkyl; COOC₁₋₂alkyl; aryl- or substituted aryl-radicals.

Preferably, R₁ to R₄ independently of each other are hydrogen, C₁₋₂ alkyl, substituted C₂₋₃-alkyl; OC₁₋₂alkyl; Oaryl; COC₁₋₂alkyl; COOC₁₋₂alkl or aryl-radicals.

In a further embodiment of the present invention, there is provided a process for improving the light fastness of a textile material characterised in that the material is treated with an aqueous dispersion comprising at least one of the compound of formula (I) as above defined, the treatment with the aqueous dispersion being before, during or after a long or short bath, an exhaust or slop-padding dyeing process or a printing process.

The present invention further provides use of the aqueous dispersions of the invention for treatment of a textile material in order to improve the light fastness of the thus textile material.

The materials which are suitable for treatment according to the process of the present invention, are textile materials which are in the form of fibres, threads or materials produced therefrom, which may for example be woven or knitted. The textile materials may be any fully- or semi-synthetic or natural material, mixtures of either synthetic or natural materials or mixtures of both synthetic and natural materials such as for example polyester-cotton mixtures. It has been found that the dispersions of the present invention show particularly good results when used for the treatment of polyester textile materials. The textile materials of the present invention, namely those which have been treated with an aqueous dispersion of the present invention are particularly useful for use as automobile upholstery. Due to the high sublimation fastness of the compounds used in the aqueous dispersions and processes of the present invention, sublimation of the compounds under high temperatures, as are commonly experienced inside an automobile which is left in direct sunshine, either does not occur or occurs only to a minimal extent, that is the compounds can be described as being sublimation stable. The sublimation stability can be shown by thermo-gravimetric analysis. This sublimation stability is an important advantage in the automobile industry since a compound which is stable to sublimation does not sublime or sublimes to a very low extent and accordingly one does not observe the fogging of the car wind screen which occurs with compounds which sublime.

The aqueous dispersions of the present invention are applied to the material to be treated before, during or after a long or short bath, an exhaust or slop-padding dyeing process or printing process. The long or short bath, the exhaust or slop-padding dyeing process or printing process used in the process of the present invention are all conventional processes.

Fixing of the U.V. absorbing compound to the textile material is similarly effected in a conventional manner, such as by thermo-fixation. Fixing may occur during the dyeing process for example during exhaust dyeing or it may take place subsequent to the dyeing or printing process by means of a conventional heating step. A typical temperature at which fixing may be carried out is at about 180° C. for a period of about 1 minute.

It is particularly advantageous if the aqueous dispersions of the present invention are present during the dyeing process, that is they are added to the dye bath. Accordingly in a preferred embodiment of the process according to the present invention there is provided a process for improving the light fastness of a textile material characterised in that the material is treated with an aqueous dispersion comprising at least one of the compounds of formula (I) as above defined, the treatment with the aqueous dispersion being during the dyeing process.

The compounds which are employed in the aqueous dispersions of the present invention all exhibit a high level of sublimation fastness. This property is particularly important in that it allows the compounds to be fixed by means of thermo-fixation without adversely effecting the properties of the compound. Furthermore the compounds used in the aqueous dispersions of the present invention, demonstrate very good exhaustion and are therefore particularly suitable for treating textiles according to the exhaust or slop or padding dyeing processes.

The compounds of formula (1) may be employed in admixture with other U.V. absorbing compounds which can be formed into an aqueous dispersion. Accordingly in a further embodiment of the present invention there is provided an aqueous dispersion comprising at least one of the compounds of formulae I and a further water-dispersible U.V. absorber.

The compounds of the present invention are generally employed in quantities of 0.05 to 5.0%, preferably 0.1 to 3.5% and more preferably 0.2 to 3.0%, the percentages being based on the dry weight of the textile material to be treated.

Textile materials which have been treated with an aqueous dispersion of the present invention are also an embodiment of the present invention. In addition to possessing the advantage of having been treated with a U.V. absorber which displays sublimation stability, as above discussed, and accordingly being particularly of interest to the automobile upholstery industry, such textiles also offer the advantage of comprising a U.V. absorbing compound and accordingly are suitable for use in the manufacture of clothes. Clothing manufactured utilising the textiles of the present invention protect the wearer against the harmful U.V. radiation from the sun.

The textile materials treated with a suspension comprising a compound of the formula (I) improves the sun protection factor (SPF) of the treated textile material and of object, clothes and/or garments manufactured thereof. The SPF rating of a sun protectant (sun cream or clothing) may be defined as the multiple of the time taken for the average person wearing the sun protectant to suffer sun burning under average exposure to sun. For example, if an average person would normally suffer sun burn after 30 minutes under standard exposure conditions, a sun protectant having an SPF rating of 5 would extend the period of protection from 30 minutes to 2 hours and 30 minutes.

Accordingly in a yet further embodiment of the present invention, there is provided a process for improving the protection afforded a wearer of clothes manufactured from a textile material according to the invention, against the harmful U.V. radiation from the sun.

For example this further embodiment of the present invention comprises a process for improving the protection of a person against the harmful U.V. radiation from the sun characterised in that the person wears clothes or garments manufactured from a textile material treated according to the present invention.

The present invention comprises further a process for improving the sun protection factor of a textile material characterised in that the textile material is treated with a dispersion according to our invention.

The compounds of formula (I) can be produced as described i.e. in U.S. Pat. No. 2,794,052, in Monatsh Chem. 116, pp. 353-356 (1985), in Synthesis, pp. 533-542 (1972) or EP711744A1.

The following examples illustrate the invention. In the examples all parts and percentages are by weight unless indicated to the contrary, and all temperatures are given in degrees Centigrade.

### EXAMPLE 1

5 parts of the compound of formula (Ia)

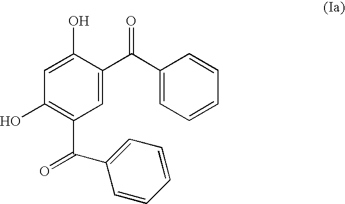

is ground for 3 hours in an appropriate dispersing apparatus with 2 parts of a dispersing agent based on oleyl alcohouethylene oxide (addition product), 83 parts of water and 150 parts of glass pearls. The average particle size of the active substance is then less than 5 μm, the glass pearls are separated from the dispersion using a sieve, and washed out with 10 parts of water. The dispersion obtained contains 5% active substance.

### EXAMPLE 2

50 parts of a polyester-tricot material (commercial name “Tersuisse”) is placed in 1000 parts of an aqueous liquor, which contains

0.04 Parts of Foron Yellow AS-FL (Trademark of Clariant AG., Muttenz, Switzerland)

0.022 parts of Foron Red AS-LKJ (Trademark of Clariant AG, Muttenz, Switzerland)

0.021 parts of Foron Blue AS-BGL 200 (Trademark of Clariant AG, Muttenz, Switzerland)

5.0 parts of the dispersion of example 1 and

2.0 parts of ammonium sulphate,

the pH value of the bath is adjusted to 4.5 in a HT dyeing apparatus, the material is treated for 5 minutes at 60° C., then the bath is heated to 130° C. over ca. 30 minutes, and dyeing is effected at this temperature for 30 minutes. After cooling to 60° C., the dyeing is removed from the bath, rinsed, cleaned for 20 minutes at 80° C. in the usual way with an alkaline solution of sodium hydrosulphite, rinsed with warm water, neutralized with acetic acid, centrifuged, and the remaining moisture dried in the air. Part of the dyeing is then additionally treated for 60 seconds at 210° C.

A very good light fastness and sublimation fastness is obtained as shown in the table 1 after example 3

### EXAMPLE 3

A polyester-tricot material is dyed as in Example 2 but 7.5 parts of the dispersion of example 1 is used.

A very good light fastness and sublimation fastness is obtained as shown in the table 1.

TABLE 1

| | 2 cycles FAKRA^{(*)} | | 4 cycles FAKRA^{(*)} | |
|---|---|---|---|---|
| | no | | no | |
| | thermo- | thermofixing | thermo- | thermofixing |
| | fixing | 60 sec/210° C. | fixing | 60 sec/210° C. |
| Example 2 | 3.3 | 3.1 | 2.6 | 2.6 |
| Example 3 | 3.5 | 3.3 | 2.7 | 2.6 |
| no UV-absorber | 2.5 | 2.6 | 1.9 | 2.0 |

^{(*)}FAKRA is a test according to ISO 105/B02: Exposure in Xenotest 450 equipped with a Xenon arc source; black standard temperature 45° C., relative humidity 45 ± 5%. The number of cycles is indicated in table 1; in DIN 75202/H: 1 cycle FAKRA is 54 hours exposure.

### EXAMPLE 4

In this blank experiment a polyester Interlock material is treated without any dye but with the UV-absorber. A adapted process according to Example 2 is used but 10 parts of the dispersion of example 1 is used, 1.0 g/l sodium acetate, the pH is adjusted to a pH of 4.5. (no dyestuff is used). The polyester Interlock material is treated during 30 minutes at 130° C. The polyester Interlock material ist rinsed with cold water and reductively cleaned using Sandopur MCL (Trademark of Clariant International LTD., Muttenz, Switzerland). The whitegrade (whiteness) is measured using a reflectance meter. The result is given in Table 2 (after example 5).

### EXAMPLE 5

In this blank experiment a polyester Interlock material is treated without any dye but with the UV-absorber. 20 parts of the dispersion of example 1 is used. The whitegrade (whiteness) is measured using a reflectance meter. The result is given in Table 2:

TABLE 2

| | Whitegrade |
|---|---|
| | CIE |
| Example 4 | 81 |
| Example 5 | 76 |
| untreated polyester sample | 86 |

### EXAMPLE 6

15 parts of the compound of formula (Ia) is mixed in an appropriate dispersing apparatus with 10 parts of 1,3-Bis (4-benzoyl-3-hydroxyphenoxy)-2-propanol, 15 parts of a commercial condensation product of ditolylethersulfonate and formaldehyde, 0.25 parts of a fungicide, 2 parts of a copolymer of ethylene oxide and propylene oxide and 57.75 parts of demineralized water and ground for about 4 hours with glass pearls in a pearl mill until the average particle size is less than 1 μm. The glass pearls are separated from the dispersion using a sieve.

### EXAMPLE 7

50 parts of a polyester-tricot material (commercial name “Tersuisse”) is placed in 1000 parts of an aqueous liquor, which contains

0.04 Parts of Foron Yellow AS-FL (Trademark of Clariant AG, Muttenz, Switzerland)

0.022 parts of Foron Red AS-LKJ (Trademark of Clariant AG, Muttenz, Switzerland)

0.021 parts of Foron Blue AS-BGL 200 (Trademark of AG, Muttenz, Switzerland)

1.0 parts of the dispersion of example 6 and

2.0 parts of ammonium sulphate,

the pH value of the bath is adjusted to 4.5 in a HT dyeing apparatus, the material is treated for 5 minutes at 60° C., then the bath is heated to 130° C. over ca. 30 minutes and dyeing is effected at this temperature for 30 minutes. After cooling to 60° C., the dyeing is removed from the bath, rinsed, cleaned under reducing conditions, neutralized and dried in the air. Part of the dyeing is then additionally fixed at different conditions.

A very good light fastness and sublimation fastness is obtained.

1. A process for improving the light fastness of a textile material characterized in that the material is treated with an aqueous dispersion comprising at least one U.V. absorbing compound of the following formula I 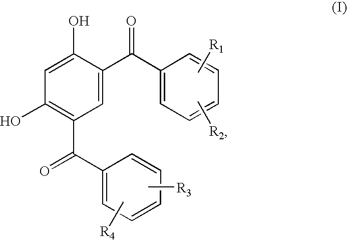
wherein
R₁ to R₄ independently of each other are hydrogen; C₁₄ alkyl; substituted C₂₄alkyl; —OC₁₋₄alkyl; Oaryl; COC₁₋₂alkyl; COOC₁₋₂alkyl; aryl- or substituted aryl-radicals,
the treatment with the aqueous dispersion being before, during or after a long or short bath, an exhaust or slop-padding dyeing process or a printing process.

2. A process as claimed in claim 1 wherein
R₁ to R₄ independently of each other are hydrogen; C₁₋₂ alkyl;
substituted C₂₋₃-alkyl; OC₁₋₂alkyl; Oaryl; COC₁₋₂alkyl;
COOC₁₋₂alkyl or aryl-radicals.

3. A process as claimed in claim 1 or 2 characterized in that the aqueous dispersion comprises a further water-dispersible U.V. absorber.

4. A process as claimed in any of claims 1 to 4 wherein a compound of formula (1) or a mixture thereof are employed in quantities of 0.05 to 5.0%, preferably 0.1 to 3.5% and more preferably 0.2 to 3.0%, the percentages being based on the dry weight of the textile material to be treated.

5. Textile material obtainable by treating a textile material according to a process as claimed in any of claims 1 to 4.

6. Use of a textile as claimed in claim 5 as automobile upholstery or as an article of clothing.

7. A process for improving the sun protection factor of a textile material characterized in that the textile material is treated according to a process according to one of claims 1 to 4.
